(19) United States
(12) Patent Application Publication
(10) Pub. No.: US 2026/0102862 A1
(43) Pub. Date: Apr. 16, 2026

(54) PANEL RELEASE DEVICE

(71) Applicant: USUN TECHNOLOGY CO., LTD., Taoyuan (TW)

(72) Inventors: Chiu-Fong HUANG, Taoyuan (TW); Hsiang-Yueh YU, Taoyuan (TW)

(21) Appl. No.: 19/233,067

(22) Filed: Jun. 10, 2025

(30) Foreign Application Priority Data
Aug. 21, 2024 (TW) 113131437

(51) Int. Cl. B23Q 3/154

(52) U.S. Cl. CPC B23Q 3/1546

(57) ABSTRACT

A panel release device includes a magnetic buckle device including a first buckle member and a second buckle member respectively attached to a preset first panel and a preset second panel and respectively composed of a columnar magnetic body, a non-magnetic conductive component and a magnetic conductive component, and a magnetic key composed of a ring-shaped magnetic body with N magnetic components and S magnetic components stacked vertically. When the ring-shaped magnetic body is aligned with the non-magnetic conductive component with the same polarity, the mutually repulsive state between the ring-shaped magnetic body and the magnetic buckle device is changed to a mutually attractive and fitting state, so that the first buckle member and the second buckle member are in a mutually repulsive state with the same polarity, and the preset first panel and the preset second panel are unlocked and separated.

This application claims the priority benefit of Taiwan patent application number 113131437, filed on Aug. 21, 2024.

### BACKGROUND OF THE INVENTION

### 1. Field of the Invention

The present invention is a panel release device, particularly a first buckle member attached to a preset first panel and a second buckle member attached to a preset second panel, both the first buckle member and the second buckle member are composed of a solid cylindrical magnetic core body. The preset first panel can be a fixed jig and the preset second panel can be a processing object, and the two are stacked or wedged into each other. The magnetic key formed by the ring-shaped magnetic body is aligned with the non-magnetic conductive component on the top side of the magnetic buckle device with the same polarity, and the mutually repulsive state of the ring-shaped magnetic body and the magnetic buckle device is changed to a mutually attractive and fitting state through the magnetic field line flow, so that the first buckle member and the second buckle member can be in a mutually repulsive state with the same polarity, and the preset first panel and the preset second panel can be in a release and separation state. The problems of two solid magnets being difficult to separate and processing speed being slow in conventional magnetic processing operations can be improved. In addition, the magnetic combination structure of the magnetic buckle device and the magnetic key proposed in the present invention has the advantages of accurate alignment and no misalignment.

### 2. Description of the Related Art

With the continuous progress of the times, the manufacturing industry hopes to carry out processing, production, and transportation in an environment completely free of dust and fine matter. Therefore, non-contact transmission methods have been developed to transport or fix various components. By using the magnetic pole characteristics of the magnet, the principle of polar repulsion and attraction between the N pole and S pole of the magnet, magnets are embedded in the processing object and the jig and temporarily fixed through the principle of opposite polarity attraction. After the workpiece is processed, the jig and its magnets are removed to achieve the purpose of abandoning the locking, clamping or bonding methods that may generate dust.

It is known that magnetic processing is to use two solid magnets with different polarities (S pole and N pole) to attract the processing object and the jig. As the size and weight of the workpiece and jig increase, the magnetic force of the two solid magnets must also be increased, or the number of solid magnets must be increased. Although this can increase the magnetic attraction between the solid magnets, it also makes it difficult to separate the two solid magnets, which can easily affect the progress of the processing. As the number of solid magnets increases, the processing platform is also affected by magnetic attraction, resulting in incorrect movement. Although this type of magnetic processing operation can achieve a dust-proof effect by temporarily fixing, it is difficult to solve the problems of difficulty in unfastening and separation and slow processing speed during actual implementation, which needs to be improved.

### SUMMARY OF THE INVENTION

Therefore, in view of the above problems and deficiencies, the inventor collected relevant information and, after multiple evaluations and considerations, designed the invention of this panel release device.

The main object of the present invention is to provide a panel release device, which comprises a magnetic buckle device and a magnetic key. The magnetic buckle device comprises a first buckle member attached to a preset first panel, and a second buckle member attached to a preset second panel. The preset first panel and the preset second panel are stacked or wedged into each other. The first buckle member and the second buckle member are in a mutually attracted state and have the same structure. The first buckle member and the second buckle member each comprise a columnar magnetic body formed by vertically stacking an S-pole magnetic component and an N-pole magnetic component, a non-magnetic conductive component arranged on the top side of the columnar magnetic body, and a magnetic conductive component arranged on the opposing bottom side of the columnar magnetic body. The magnetic key is composed of a ring-shaped magnetic) body formed by vertically stacking an N magnetic component and an S magnetic component. The ring-shaped magnetic body has a hollow inner diameter approximately equal to the diameter of the columnar magnetic. When the ring-shaped magnetic body is aligned with and close to the non-magnetic conductive component on the top side of the magnetic buckle device with the same polarity, the mutually repulsive state of the ring-shaped magnetic body and the magnetic buckle device is changed to a mutually attractive and fitting state through the flow of magnetic lines of force, and the magnetic field lines at the bottom side of the ring-shaped magnetic body are guided to the magnetic conductive component at the bottom side of the magnetic buckle device, so that the first buckle member and the second buckle member are in a mutually repulsive state with the same polarity, and the preset first panel and the preset second panel are in an unlocked and separated state.

The first buckle member attached to a preset first panel and the second buckle member attached to a preset second panel, both are composed of a solid cylindrical magnetic core body. The preset first panel can be a fixed jig and the preset second panel can be a processing object, and the two are stacked or wedged into each other. The magnetic key formed by the ring-shaped magnetic body is aligned with the non-magnetic conductive component on the top side of the magnetic buckle device with the same polarity, and the mutually repulsive state of the ring-shaped magnetic body and the magnetic buckle device is changed to a mutually attractive and fitting state through the magnetic field line flow, so that the first buckle member and the second buckle member can be in a mutually repulsive state with the same polarity, and the preset first panel and the preset second panel can be in a release and separation state. The problems of two solid magnets being difficult to separate and processing speed being slow in conventional magnetic processing operations can be improved. In addition, the magnetic combination structure of the magnetic buckle device and the magnetic key proposed in the present invention has the advantages of accurate alignment and no misalignment.

Another object of the present invention is that when the ring-shaped magnetic body and the magnetic buckle device are in a mutually attractive and fitting state, the inner diameter of the ring-shaped magnetic body is aligned with the columnar magnetic body of the magnetic buckle device.

Still another object of the present invention is that the magnetic key is installed in a linearly movable jig or a robot arm; and the preset first panel can be a jig and the preset second panel can be a processing object.

Still another object of the present invention is that when the diameter of the magnetic conductive component of the magnetic buckle device is larger, more magnetic lines of force can be received from the bottom of the ring-shaped magnetic body, and the mutual repulsion force between the first buckle member and the second buckle member is greater; on the contrary, when the diameter of the magnetic conductive component of the magnetic buckle device is smaller, the amount of magnetic field lines that can be received from the bottom side of the ring-shaped magnetic body is smaller, and the mutual repulsion force between the first buckle member and the second buckle member is smaller.

Still another object of the present invention is that when the height or outer diameter of the ring-shaped magnetic body is larger, the magnetic conductive component of the magnetic buckle device can receive more magnetic field lines at the bottom of the ring-shaped magnetic body, and the mutual repulsion force between the first buckle member and the second buckle member is larger; on the contrary, when the height or outer diameter of the ring-shaped magnetic body is smaller, the magnetic conductive component of the magnetic buckle device can receive fewer magnetic field lines on the bottom side of the ring-shaped magnetic body, and the mutual repulsion force between the first buckle member and the second buckle member is smaller.

### BRIEF DESCRIPTION OF THE DRAWINGS

FIG. 1 is a side cross-sectional view of the panel release device of the present invention before unlocking.

FIG. 2 is a side cross-sectional view of the panel release device of the present invention after being unlocked.

FIG. 3 is a diagram showing the first implementation of the magnetic key of the present invention after unlocking.

FIG. 4 is a diagram showing the second implementation of the magnetic key of the present invention after unlocking.

### DETAILED DESCRIPTION OF+ THE PREFERRED EMBODIMENT

In order to achieve the above-mentioned objects and effect, the technical means and structure adopted by the present invention are described in detail with reference to the preferred embodiment and annexed drawings of the present invention, and its features and functions are as follows for a complete understanding.

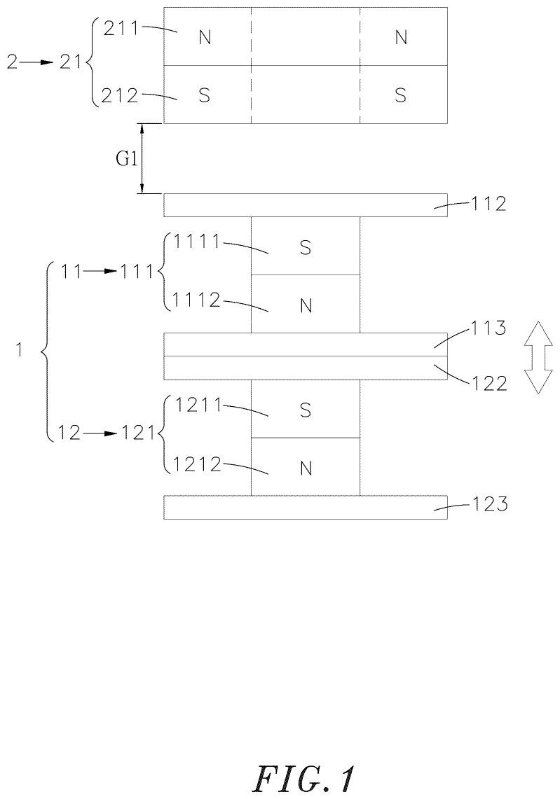

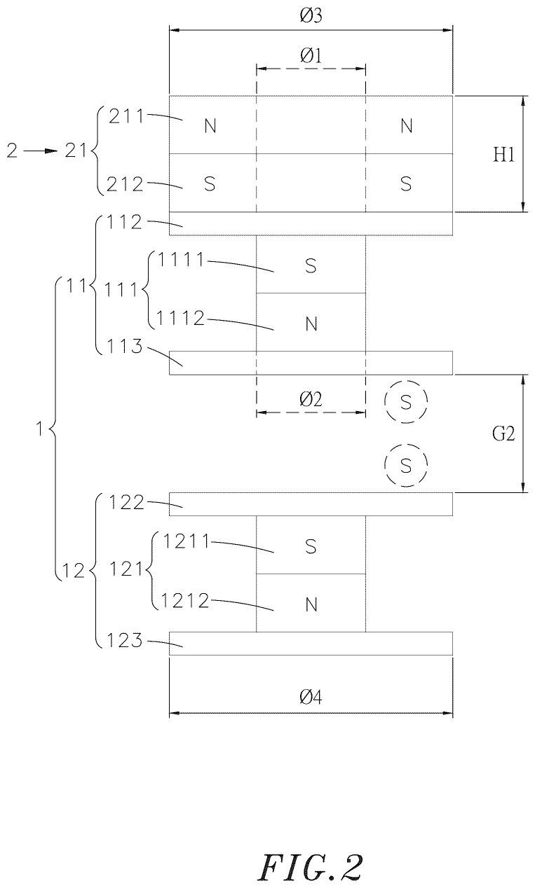

Referring to FIGS. 1 and 2, which are respectively a side cross-sectional view of the panel release device of the present invention before unlocking and a side cross-sectional view of the panel release device of the present invention after being unlocked. As can be clearly seen from the drawings, the panel release device of the present invention mainly comprises a magnetic buckle device 1 and a magnetic key 2, and its main components and features are described in detail as follows:

The magnetic buckle device 1 comprises a first buckle member 11 attached to a preset first panel (not shown) and a second buckle member 12 attached to a preset second panel (not shown). The preset first panel and the preset second panel are stacked or wedged into each other. The first buckle member 11 and the second buckle member 12 are in a mutually attracted state and have the same structure. The first buckle member 11 or the second buckle member 12 comprises a columnar magnetic body (111, 121) formed by vertically stacking S-pole magnetic components (1111, 1211) and N-pole magnetic components (1112, 1212), a non-magnetic conductive component (112, 122) arranged on the top side of the columnar magnetic body (111, 121) and a magnetic conductive component (113, 123) arranged on the bottom side of the columnar magnetic body (111, 121).

The magnetic key 2 is composed of a ring-shaped magnetic body 21 formed by vertically stacking N magnetic components 211 and S magnetic components 212. The ring-shaped magnetic body 21 has a hollow inner diameter Ø1, and the inner diameter Ø1 is approximately equal to the diameter Ø2 of the columnar magnetic body (111, 121). According to the ring-shaped magnetic body 21 being aligned with the non-magnetic conductive component 112 on the top side of the magnetic buckle device 1 with the same polarity and having a unbuttoning distance G1, the mutually repulsive state of the ring-shaped magnetic body 21 and the magnetic buckle device 1 is changed to a mutually attractive and fitting state through the flow of magnetic lines of force, and the magnetic field lines at the bottom of the ring-shaped magnetic body 21 are guided to the magnetic conductive component 113 at the bottom of the magnetic buckle device 1, so that the first buckle member 11 and the second buckle member 12 are in a mutually repulsive state with the same polarity and having a mutually repulsive distance G2, and the preset first panel and the preset second panel are in an unfastened and separated state.

When the ring-shaped magnetic body 21 and the magnetic buckle device 1 are in a mutually attractive and fitting state, the inner diameter Ø1 of the ring-shaped magnetic body 21 is located opposite to the columnar magnetic body (111, 121) of the magnetic buckle device 1.

The magnetic key 2 is installed in a linearly movable jig (not shown) or a robot arm (not shown); the preset first panel may be a jig (not shown) and the preset second panel may be a processing object (not shown).

The columnar magnetic body (111, 121) is composed of a cylinder, an elliptical cylinder, a rectangular cylinder, a hexagonal cylinder or a polygonal cylinder. The ring-shaped magnetic body 21 is in the shape of a circular ring, an elliptical ring, a rectangular ring, a hexagonal ring, or a polygonal ring. The non-magnetic conductive component (112, 122) is made of plastic or acrylic material; and the magnetic conductive component (113, 123) is made of iron, iron alloy, stainless steel or nickel alloy material.

The magnetic conductive component (113, 123) is implemented by using iron sheets, so that the first buckle member 11 attached to the preset first panel (fixed jig) and the second buckle member 12 attached to the preset second panel (processing object) and the magnetic key 2 attached to the linearly movable jig or the robot arm generate mutual attraction and mutual repulsion. Therefore, the magnetic conductive component (113, 123) is not necessarily designed in the form of iron sheets. It can also be made of iron powder or other powder with magnetic properties painted on the bottom of the columnar magnetic body (111, 121) in the form of paint to provide the ring-shaped magnetic body 21 with magnetic attraction. Therefore, the bottom side of the columnar magnetic body (111, 121) only needs to have magnetic conductivity. Such simple equalization and modification do not limit the protection scope of the present invention and is therefore warranted.

Based on the above, when the present invention is actually applied in an automated assembly factory, align the ring-shaped magnetic body 21 of the magnetic key 2 installed in the linearly movable jig or robot arm provided at the processing machine close to the top side of the non-magnetic conductive component 112 of the magnetic buckle device 1 with the same polarity. The mutually repulsive state of the ring-shaped magnetic body 21 and the first buckle member 11 attached to the fixed jig is changed to a mutually attractive and fitting state through the flow of magnetic field lines, so as to achieve a non-locking, non-clamping and non-adhesive fixed structure that does not generate dust, and the magnetic field lines at the bottom of the ring-shaped magnetic body 21 are guided to the magnetic conductive component 113 at the bottom of the first buckle member 11, so that the second buckle member 12 attached to the fixed processing object and the first buckle member 11 present a mutually repulsive state of the same polarity, and the fixed jig and the processing object are in an unfastened and separated state. The second buckle member 12 can magnetically attract more processing objects (not shown, such as the third buckle member, the fourth buckle member or more buckle members). This simple change is also within the scope of protection of the present invention, and all processing objects can be released and separated at the same time through the magnetic key 2. Then, the first buckle member 11 (fixed jig) adhered to the magnetic key 2 is moved to the original position of the processing machine through the linear movable jig or the robot arm, and then wait for the next set of processing objects to arrive at the processing station positioning position before magnetically fixing the processing objects.

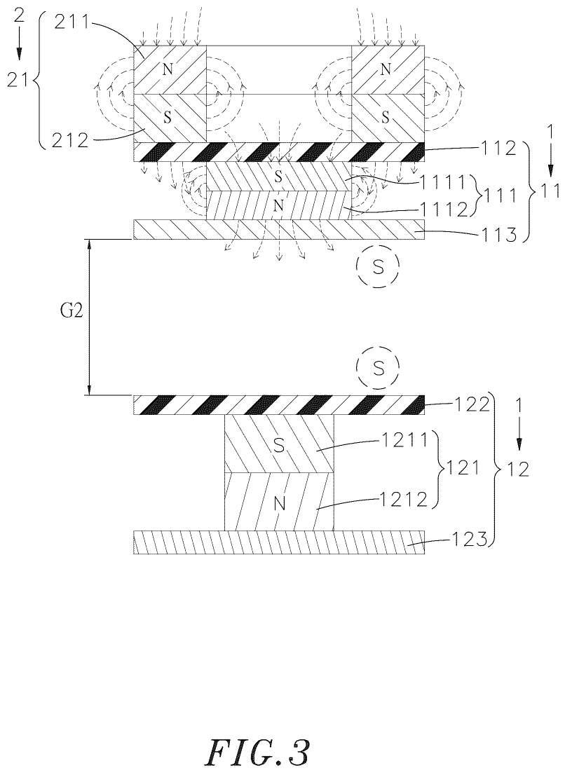

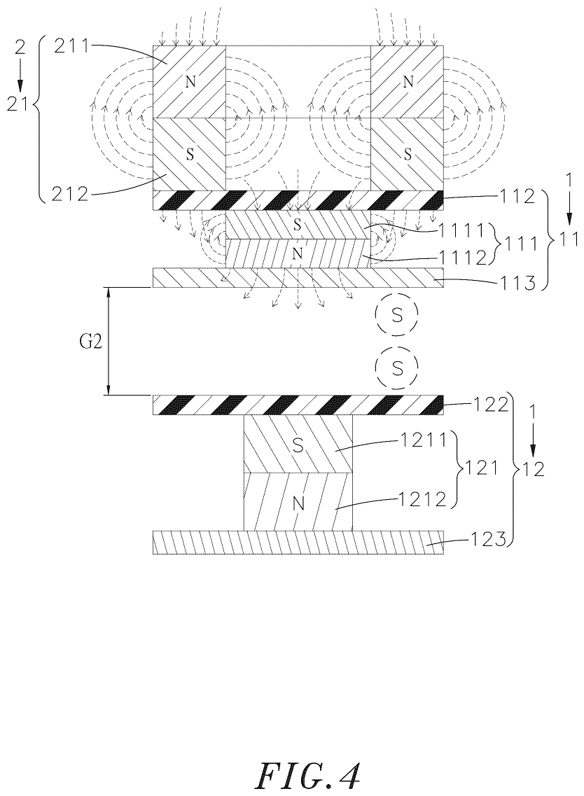

Please refer to FIGS. 3 and 4, which are diagrams showing the first and second implementations of the magnetic key of the present invention after unlocking. The larger the diameter Ø4 of the magnetic conductive component (113, 123) of the magnetic buckle device 1 is, the more magnetic field lines can be received from the bottom side of the ring-shaped magnetic body 21, and the greater the mutual repulsive force between the first buckle member 11 and the second buckle member 12 is (the mutually repulsive distance G2 becomes larger). On the contrary, when the diameter Ø4 of the magnetic conductive component 113 of the magnetic buckle device 1 is smaller, the number of magnetic field lines that can be received from the bottom side of the ring-shaped magnetic body 21 is smaller, and the mutual repulsive force between the first buckle member 11 and the second buckle member 12 is smaller (the mutually repulsive distance G2 becomes smaller). The size of the magnetic conductive component will cause the repulsive force to rebound within a certain range. The test data of various sizes of magnetic buckle device 1, ring-shaped magnetic body 21 and magnetic conductive component (113, 123) are as follows:

| | | | Mutually | | Magnetic |
|---|---|---|---|---|---|
| | | Center | edge | Number of | conductive |
| | | attractive | repulsive | magnetic | component |
| | | distance | distance | lines of | maximum |
| | | (mm) of | (mm) of | force of | attractive |
| | | magnetic | magnetic | magnetic | force after |
| Magnetic | Ring-shaped | conductive | conductive | conductive | magnetic |
| buckle device | magnetic body | component | component | component | conduction |
| Magnet | Outer | 4 | 5 | Ø20 | 600 |
| specification: | diameter: Ø40 | 2 | 3 | Ø30 | 1000 |
| ND35 | Inner | 3 | 4 | Ø35 | 1400 |
| Columnar | diameter: Ø20 | 3 | 4 | Ø40 | 1300 |
| magnetic body | Maximum | 4 | 5 | Ø45 | 1200 |
| Diameter: Ø20 | attractive | 4 | 5 | Ø50 | 1200 |
| Maximum | force: 10 T | | | | |
| attractive | | | | | |
| force: 3 T | | | | | |
| Magnet | Outer | 4 | 5 | Ø25 | 300 |
| specification: | diameter: Ø40 | 2 | 3 | Ø30 | 700 |
| ND35 | Inner | 3 | 4 | Ø35 | 1100 |
| Columnar | diameter: Ø20 | 3 | 4 | Ø40 | 1200 |
| magnetic body | Maximum | 4 | 5 | Ø45 | 1200 |
| Diameter: Ø25 | attractive | 5 | 6 | Ø50 | 1000 |
| Maximum | force: 10 T | | | | |
| attractive | | | | | |
| force: 3 T | | | | | |

Referring to FIGS. 3 and 4 again, when the height H1 or the outer diameter Ø3 of the ring-shaped magnetic body 21 is larger, the magnetic conductive component 113 of the magnetic buckle device 1 can receive more magnetic field lines on the bottom side of the ring-shaped magnetic body 21, and the mutual repulsive force between the first buckle member 11 and the second buckle member 12 is larger (the mutually repulsive distance G2 becomes larger). On the contrary, when the height H1 or the outer diameter Ø3 of the ring-shaped magnetic body 21 is smaller, the magnetic conductive component 113 of the magnetic buckle device 1 can receive fewer magnetic field lines on the bottom side of the ring-shaped magnetic body 21, and the mutual repulsive force between the first buckle member 11 and the second buckle member 12 is smaller (the mutually repulsive distance G2 becomes smaller).

In order to verify the technical contents disclosed in FIGS. 3 and 4, a comparison table of the height of the ring-shaped magnetic body 21, the number of magnetic lines of force of the magnetic conductive component (113, 123), and the mutually repulsive distance G2 generated between the first buckle member 11 and the second buckle member 12 is presented as follows.

| | Outer and | | Magnetic | Center | Edge | Number of |
|---|---|---|---|---|---|---|
| | inner | Hight of | flux of | attraction | repulsive | magnetic |
| | diameters | ring- | ring- | distance | distance | lines of |
| | of ring- | shaped | shaped | (mm) of | (mm) of | force of |
| | shaped | magnetic | magnetic | magnetic | magnetic | magnetic |
| Magnetic | magnetic | body | body | conductive | conductive | conductive |
| buckle device | body | (mm) | Gauss (G) | component | component | component |
| Magnet | Outer | 5 | 3800 | | 7 | Ø50*1 T |
| specification: | diameter: Ø50 | 6 | 4300 | 5 | 6 | |
| ND35 | Inner | 7 | 4200 | 5 | 6 | |
| Columnar | diameter: Ø25 | 8 | 4500 | 3 | 4 | |
| magnetic | | 9 | 4600 | 3 | 4 | |
| body | | | | | | |
| Diameter: | | | | | | |
| Ø30 | | | | | | |
| Maximum | | | | | | |
| attractive | | | | | | |
| force: 3 T | | | | | | |

The main features of the present invention are as follows. The first buckle member 11 attached to a preset first panel and the second buckle member 12 attached to a preset second panel, both are composed of a solid cylindrical magnetic core body. The preset first panel can be a fixed jig and the preset second panel can be a processing object, and the two are stacked or wedged into each other. The magnetic key 2 formed by the ring-shaped magnetic body 21 is aligned with the non-magnetic conductive component 112 on the top side of the magnetic buckle device 1 with the same polarity, and the mutually repulsive state of the ring-shaped magnetic body 21 and the magnetic buckle device 1 is changed to a mutually attractive and fitting state through the magnetic field line flow, so that the first buckle member 11 and the second buckle member 12 can be in a mutually repulsive state with the same polarity, and the preset first panel and the preset second panel can be in a release and separation state. The problems of two solid magnets being difficult to separate and processing speed being slow in conventional magnetic processing operations can be improved. In addition, the magnetic combination structure of the magnetic buckle device 1 and the magnetic key 2 proposed in the present invention has the advantages of accurate alignment and no misalignment.

The above is merely a preferred embodiment of the present invention and is not intended to limit the patent scope of the present invention. Therefore, all simple modifications and equivalent structural changes made by using the contents of the description and drawings of the present invention should be included in the patent scope of the present invention and should be declared.

In summary, the panel release device of the present invention can achieve its efficacy and purpose when used, so the present invention is truly an invention with excellent practicality. In order to meet the application requirements for invention patents, we have filed an application in accordance with the law. We hope that the review committee will approve the present invention as soon as possible to protect the inventor's hard work in research and development. If the review committee has any questions, please feel free to write to us for instructions. The inventor will do his best to cooperate and will be grateful for the convenience.

What the invention claimed is:

1. A panel release device, comprising:
a magnetic buckle device comprising a first buckle member attached to a preset first panel and a second buckle member attached to a preset second panel, said preset first panel and said preset second panel being stacked or wedged into each other, said first buckle member and said second buckle member being in a mutually attracted state and having the same structure, said first buckle member and said second buckle member each comprising a columnar magnetic body formed by vertically stacking an S-pole magnetic component and an N-pole magnetic component, a non-magnetic conductive component arranged on a top side of said columnar magnetic body and a magnetic conductive component arranged on an opposing bottom side of said columnar magnetic body; and
a magnetic key composed of a ring-shaped magnetic body formed by vertically stacking an N magnetic component and an S magnetic component, said ring-shaped magnetic body having a hollow inner diameter approximately equal to diameter of said columnar magnetic body;
wherein when said ring-shaped magnetic body is aligned with and close to said non-magnetic conductive component on the top side of said magnetic buckle device with same polarity, a mutually repulsive state of said ring-shaped magnetic body and said magnetic buckle device is changed to a mutually attractive and fitting state through the flow of magnetic lines of force, and the magnetic field lines at a bottom side of said ring-shaped magnetic body are guided to said magnetic conductive component at the bottom side of the magnetic buckle device, so that said first buckle member and said second buckle member are in a mutually repulsive state with same polarity, and said preset first panel and said preset second panel are in an unlocked and separated state.

2. The panel release device as claimed in claim 1, wherein when said ring-shaped magnetic body and said magnetic buckle device are in a mutually attractive and fitting state, said hollow inner diameter of said ring-shaped magnetic body is aligned with said columnar magnetic body of said magnetic buckle device.

3. The panel release device as claimed in claim 1, wherein said magnetic key is installed in a linearly movable jig or a robot arm; said preset first panel is a jig and said preset second panel may be a processing object.

4. The panel release device as claimed in claim 1, wherein when the diameter of said magnetic conductive component of said magnetic buckle device is relatively larger, relatively more magnetic field lines are received from the bottom side of said ring-shaped magnetic body, and the mutual repulsion force between said first buckle member and said second buckle member is relatively larger; on the contrary, when the diameter of said magnetic conductive component of said magnetic buckle device is relatively smaller, the amount of magnetic field lines received from the bottom side of said ring-shaped magnetic body is relatively smaller, and the mutual repulsion force between said first buckle member and said second buckle member is relatively smaller.

5. The panel release device as claimed in claim 1, wherein when height or outer diameter of said ring-shaped magnetic body is relatively larger, said magnetic conductive component of said magnetic buckle device receives relatively more magnetic field lines from the bottom side of said ring-shaped magnetic body, and the mutual repulsion force between said first buckle member and said second buckle member is relatively larger; on the contrary, when the height or outer diameter of said ring-shaped magnetic body is relatively smaller, said magnetic conductive component of said magnetic buckle device receives relatively fewer magnetic field lines on the bottom side of said ring-shaped magnetic body, and the mutual repulsion force between said first buckle member and said second buckle member is relatively smaller.

6. The panel release device as claimed in claim 1, wherein said columnar magnetic body is selectively composed of a cylinder, an elliptical cylinder, a rectangular cylinder, a hexagonal cylinder or a polygonal cylinder.

7. The panel release device as claimed in claim 1, wherein said ring-shaped magnetic body is selectively in the form of a circular ring, an elliptical ring, a rectangular ring, a hexagonal ring or a polygonal ring.

8. The panel release device as claimed in claim 1, wherein said non-magnetic conductive component is selectively made of plastic or acrylic; and said magnetic conductive component is selectively made of iron, iron alloy, stainless steel or nickel alloy.
